(19) United States
(12) Patent Application Publication
(10) Pub. No.: US 2018/0134911 A1
(43) Pub. Date: May 17, 2018

(54) THREE DIMENSIONAL PRINTING COMPOSITIONS AND PROCESSES

(71) Applicant: Rapid Pattern, LLC, Genoa, OH (US)

(72) Inventor: David Neuman, Genoa, OH (US)

(21) Appl. No.: 15/811,854

(22) Filed: Nov. 14, 2017

Related U.S. Application Data
(60) Provisional application No. 62/422,062, filed on Nov. 15, 2016.

(51) Int. Cl. C09D 129/04; B29C 64/35; B29C 64/165; B29C 64/112

(52) U.S. Cl. CPC C09D 129/04; B29C 64/35; C08K 5/098; B29C 64/112; B29C 64/165

(57) ABSTRACT

Compositions suitable for three dimensional printing technology and methods for producing three dimensional printed articles and building materials are provided. The compositions are optimized for dimensional stability during and following various printing processes. In this manner, the compositions and articles printed or produced therefrom minimize any shrinkage or expansion following drying or curing of the printed or finished article and can be used to form accurate molds of digitally designed articles.

### CROSS-REFERENCE TO RELATED APPLICATIONS

This application claims the benefit of U.S. Provisional Application No. 62/422,062, filed on Nov. 15, 2016. The entire disclosure of the above application is incorporated herein by reference.

### FIELD

The present technology relates to three dimensional (3D) printing, and more particularly to compositions and 3D printing methods that obtain dimensionally stable printed articles, where the printed articles are suitable for making molds thereof.

### INTRODUCTION

This section provides background information related to the present disclosure which is not necessarily prior art.

Stereolithography and other rapid prototyping technologies are often used instead of conventional milling processes to prototype components, mechanical devices, and tooling. Rapid prototyping processes are beginning to be used in industry to reduce the time and cost that is involved in creating models, mechanical devices, housings, prototypes, or to produce small runs of finished products. One rapid prototyping technology is additive layer manufacturing (ALM) that is also referred to as three dimensional (3D) printing. Unlike milling that removes material to produce an object, ALM builds a solid object from a series of layers of material with each layer printed and formed on top of the previous layer.

One example of the ALM process begins with a computer aided design of an object and software that records a series of digital slices of the entire object. The pattern of each slice of the designed object is sent to the 3D printer to define the respective layers for construction by the printer. A thin layer of powder is spread out on a tray and the pattern of the first slice is applied to the layer of powder. ALM techniques generally use one of two different printing approaches: (1) laser or electron beams that cure or sinter material in each layer, or (2) ejection of binder material from a nozzle head to create a patterned layer. The powder materials are fused together at the locations the laser or ejected material comes in contact with the surface of the powder. Depending on the process that is used, many different types of materials can be used to form the patterned layers of the final product including, photopolymers, thermopolymers, plastics, and metal powders. Several commercial 3D printing systems are currently available that accurately deposit a liquid binder onto the surface of the powder bed using a multiple array ink-jet printing head. These systems are based upon the work of Emanuel Sach at the Massachusetts Institute of Technology in the early 1990's.

Traditional 3D printing technology is often reserved for small-scale prototyping. If the prototype formed is not accurately formed with respect to its size and dimensioning, additional steps must be taken to ensure the size of the prototype is accurate for its intended purpose. This is of particular concern for purposes where variances and tolerances in size and dimensions must be very accurate. Existing formulations for materials for forming prototypes or molds for castings may expand or contract after completion of the printed article. The expansion or contraction can be significant thus causing a need for additional processing of the printed article once completed, or requiring the article to be printed at a different size to accommodate for such expansion or contraction, which may result in a printed article outside of allowable variances and tolerances.

Accordingly, there remains a need for a formulation for a 3D printable material that does not substantially expand or contract after being formed into a printed article.

### SUMMARY

The present technology includes compositions, articles of manufacture, systems, and processes that relate to three dimensional printing and dimensionally stable printed articles that do not substantially expand or contract after being printed, where such articles are suitable for making accurate molds.

Methods are provided for three-dimensional printing of an article, the article defined by a plurality of cross sections. Such methods include providing a layer of powder, the powder capable of hardening and selectively depositing a binder to the layer of powder to form a cross section of the article, the binder including an aqueous solution that results in hardening of the powder following contact of the binder with the powder. Another layer of powder is provided across the cross section of the article and the binder is selectively deposited to the another layer of powder to form another cross section of the article. Provision of powder layers and selective deposition of binder are repeated for each remaining cross section of the article to form a printed article. The printed article is depowdered and hardened to form a dimensionally stable printed article.

In certain embodiments, the powder can include a plaster, a glidant, and an accelerating agent and the binder can include an aqueous solution. In some embodiments, the powder can include a dental plaster, a glidant, an accelerating agent, a stiffening agent, a bonding agent, a lubricant, and a desiccant and the binder can include water, glycerin, propylene glycol and a surfactant. In various embodiments, the powder can include dental plaster at 40-60 wt. %, lactose at 20-40 wt. %, accelerator at 1-5 wt. %, lubricant at 0.1-0.5 wt. %, and colloidal silica at 0.1-1.0 wt. % and the binder can include water at 80-95% wt. %, glycerin at 2.5-7.5 wt. %, and surfactant at 0.1-0.6 wt. %.

In other embodiments, the powder includes sand and a silicate and the binder includes water and propylene glycol. In particular embodiments, the powder includes sand, potassium silicate, maltodextrin, albumin, corn starch, magnesium sulfate, and bentonite and the binder includes water, glycerin, propylene glycol, and a surfactant. In some embodiments, the powder includes sand at 80-95 wt. %, silicate at 5-15 wt. %, magnesium sulfate at 0.5-4 wt. %, maltodextrin at 0.25-5 wt. %, albumin at 0.25-4 wt. %, corn starch at 0.25-2 wt. %, and bentonite at 0.1-0.5 wt. % and the binder includes water at 80-95% wt. %, glycerin at 2.5-7.5 wt. %, propylene glycol at 2.5-5 wt. % and surfactant at 0.1-0.6 wt. %.

The methods provided herein can further include washing a binder dispenser with a wash fluid, where the binder dispenser is used to selectively deposit the binder to the layer of powder. The wash fluid can include water, a detergent, and acetic acid. The binder dispenser can include an inkjet printhead.

Hardening the depowdered printed article to form a dimensionally stable printed article can include infitrating the depowdered printed article using an infiltrant. The infiltrant can include a moisture cure urethane. Infiltrating the depowdered printed article can include using vacuum to increase penetration of the infiltrant into the depowdered printed article.

The methods provided herein can further include making a mold using the dimensionally stable printed article. The dimensionally stable printed article can also be used as an internal structure of the mold. In this way, accurate molds can be made that are true with respect to dimensions and/or engineered designs related to digital data used to print the three dimensional printed article. Hardening the depowdered printed article to form a dimensionally stable printed article can also include applying carbon dioxide to the depowdered printed article or to the article as it is being printed.

Various compositions are provided herein that can serve as the basis for various reagents for three dimensional printing systems. In certain embodiments, a kit is provided that includes a powder and a binder, where the powder includes dental plaster at 40-60 wt. %, lactose at 20-40 wt. %, accelerator at 1-5 wt. %, lubricant at 0.1-0.5 wt. %, and colloidal silica at 0.1-1.0 wt. % and the binder includes water at 80-95% wt. %, glycerin at 2.5-7.5 wt. %, and, surfactant at 0.1-0.6 wt. %. Other kits include a powder and a binder, where the powder includes sand at 80-95 wt. %, silicate at 5-15 wt. %, magnesium sulfate at 0.5-2 wt. %, maltodextrin at 0.25-5 wt. %, albumin at 0.25-4 wt. %, corn starch at 0.25-2 wt. %, and bentonite at 0.1-0.5 wt. % and the binder includes water at 80-95% wt. %, glycerin at 2.5-7.5 wt. %, propylene glycol at 2.5-5 wt. %, and surfactant at 0.1-0.6 wt. %.

Further areas of applicability will become apparent from the description provided herein. The description and specific examples in this summary are intended for purposes of illustration only and are not intended to limit the scope of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

The present technology is drawn to ways to optimize three dimensional (3D) printing of an article to provide a printed article that has improved dimensional stability. One or more printed articles can be used to make an accurate mold therefrom, where the mold can be used in a molding process to form a facsimile of the printed article from another material. Compositions include a powder, a binder, a wash fluid, and an infiltrant or infiltration fluid, where each can be used separately or in combination with various 3D printing processes and 3D printing machines to produce various printed articles. Also provided is a core sand that can be used in producing one or more printed structures that can serve as internal structures for a casting process, where the one or more internal structures can be used alone or in combination with other printed articles in making a mold and/or in a casting process. The compositions and processes provided herein serve to maximize the strength and accuracy of printed articles, while minimizing material and process costs compared to other 3D printing systems. In this way, the creation of dimensionally stable and accurate 3D printed articles, such as various tooling fixtures and sand cores, are possible, where the article can dry after printing without cracking, warping, expanding, or shrinking.

Compositions and uses thereof with respect to the present technology are described herein in relation to powder bed and inkjet head 3D printing. However, it is understood that the present compositions and methods can be adapted for use in other 3D printing systems and other additive layer manufacturing processes. With respect to powder bed and inkjet head 3D printing, such methods are also known by the terms binder-jetting and drop-on-powder. Digital data, such as one or more computer-aided drafting or design (CAD) files, are used to copy, model, or design an article of interest. The article to be printed is built up from many thin cross sections of the digital data comprising a 3D model of the article. A binder dispenser, such as an inkjet printhead, moves across a layer or bed of powder, selectively depositing a liquid binder onto the powder to complete a cross section of the article. Another layer or bed of powder can then be spread across the completed cross section of the article and the binder dispensing can be repeated with each successive layer adhering to the former layer. The size of the article and the desired resolution of the printed article can determine the number of cross sections necessary to complete the printing of the article. Various powder-binder combinations can be used to form printed articles using various chemical and/or mechanical means.

In certain cases, the binder dispenser (e.g., inkjet printhead) can be washed using a wash fluid at different points in the printing process. For example, the binder dispenser can be washed between the formation of each cross section of the article, between formation of a defined number of cross sections, after dispensing a defined amount of binder, following a determination of a dispensing issue, etc. Washing can maintain accuracy in dispensing the binder onto the powder and can maintain a consistent dispensing rate and/or droplet size from the binder dispenser, for example.

When all of the cross sections are complete, unbound powder can be automatically and/or manually removed (also known as “de-powdering”), where powder that did not come in contact with binder may be reused in some instances. The de-powdered article includes the powder held together with the binder and is also referred to as a powder part or powder article. The de-powdered printed article is hardened following contact of the powder and binder during the printing process that the de-powdering does not affect the shape or dimensions of the printed article. However, the de-powdered printed article may not be robust enough for subsequent uses or processing steps and may need to be further hardened. Various hardening treatments, including various infiltration treatments, can be used to significantly increase the strength of the printed article and form a robust and dimensionally stable printed article suitable for use in forming a mold, for example.

The de-powdered article can be subjected to one or more infiltration steps or other treatments to produce properties desired in the final article, including setting, hardening, or curing of the article. Infiltration can include saturating the de-powdered article with a liquid that serves to harden the de-powdered article and attain a functional, stable, and robust article. For example, infiltration can use an infiltrant such as a wax, an adhesive including various acrylates and epoxies, a sealer including various urethanes, a hardener, etc. Infiltration can include applying the infiltrant to the depowdered article or placing or soaking the depowdered article in the infiltrant.

The de-powdered article can also be treated in other ways, in addition to or in place of infiltration. Examples of such treatments include various curing, heating, firing, sintering, energy or light beam exposure, deposition, and/or plating processes. These treatments can partially remove or eliminate a mechanical binder in the article (e.g., by burning), can consolidate the powder or a portion of the powder material (e.g., by melting), and/or can form a composite material blending the properties of the powder and the binder, including physical and/or chemical reactions between the powder and the binder. These treatments can further harden the printed article.

The resulting article is dimensionally stable and dimensionally accurate with respect to the original data and can be used in various ways, including use as a fixture, plastic injection mold, casting core box, and casting pattern tool. The article can also be subjected to further processing, including various shaping, polishing, milling, and/or forming steps. In certain embodiments, the article is used as printed to create one or more internal or interior shapes for castings that require one or more sand cores, where a sand core includes sand held together that is set in a mold to create the inside shape of a casting.

The following aspects apply to compositions of the powder used in the present technology. The powder includes a base material, such as plaster containing calcined gypsum (calcium sulfate), lime, and/or cement. The plaster in the base material can include gypsum plaster, also referred to as plaster of Paris, which includes heating or calcining gypsum to form calcium sulfate hemihydrate. Plaster can include dental plaster, which can include plaster mixed with other components including borax, potassium sulfate, and/or silica. The powder can also include a glidant that is added to the powder to improve its flowability. Examples of glidants include various saccharides including lactose and sucrose, cellulose including microcrystalline cellulose, silica including fumed silica (colloidal silicon dioxide), starch, and talc. Glidants are used to promote powder flow by reducing interparticle friction and cohesion. The powder can further include a stiffening agent and/or a bonding agent. Stiffening agents can include starches, polysaccharides, maltodextrin, insoluble fiber, etc. Bonding agents include components that typically increase viscosity of a fluid composition, where certain examples include various alcohols, oils, and waxes such as polyvinyl alcohol, cetostearyl alcohol, cetyl alcohol, cetyl esters wax, emulsifying wax, hydrogenated castor oil, paraffin, stearyl alcohol, synthetic paraffin, etc.

Other components that can be included in the powder are one or more accelerating agents, lubricants, and desiccants. Examples of accelerating agents include calcium sulfate dihydrate and mixtures of calcium sulfate dihydrate and starch, including mixtures having greater than 40 wt. % calcium sulfate dihydrate and less than 60 wt. % starch. Calcium sulfate dihydrate particles can function as seed crystals during the gypsum setting process. Other examples of accelerating agents include mixtures of greater than 80 wt. % calcium sulfate hemihydrate, greater than 15 wt. % calcium sulfate dihydrate, and less than 5 wt. % sucrose. Further examples of accelerating agents include aluminum sulfate. One or more accelerating agents can be used to tailor the time it takes to harden the base material; e.g., plaster as calcium sulfate hemihydrate. A commercial example of an accelerating agent is QwicKast™ Plaster and Gypsum Accelerator by EnvironMolds (Summit, N.J.). Examples of lubricants include stearates including magnesium stearate and calcium stearate, oils including vegetable and mineral oils, polyethylene glycol, polypropylene glycol, etc. Lubricants prevent components from clumping together and from sticking to containers, equipment, devices, etc. Examples of desiccants include sulfates and anhydrous sulfates, including anhydrous magnesium sulfate, anhydrous calcium sulfate, and/or anhydrous sodium sulfate, as well as a silica gel, potassium hydroxide, activated charcoal, calcium chloride, and/or molecular sieves including alumino silicates. Dessicants are a type of sorbent that absorb water, and can aid in maintaining the base material in an unhardened state; e.g., the gypsum setting process where the base material exists as calcium sulfate hemihydrate prior to the addition of water and hardening to calcium sulfate dihdyrate.

In certain embodiments, the powder includes a mixture of laboratory dental plaster, lactose, maltodextrin, polyvinyl alcohol (PVA), accelerator for plaster and gypsum (e.g., calcium sulfate dihydrate, aluminum sulfate, QwicKast™), magnesium sulfate, microcrystalline cellulose, magnesium stearate, and colloidal silica. Further embodiments include mixtures missing or substituting one or more of these components as well as mixtures including other components.

A powder formulation according to the present technology can include a mixture of the components provided in Table 1.

TABLE 1
Powder Formulation.

| component | weight % |
|---|---|
| base material | 50-95 |
| glidant | 1-30 |
| stiffening agent | 1-15 |
| bonding agent | 1-15 |
| accelerating agent | 1-10 |
| lubricant | 0.1-5 |
| desiccant | 1-5 |

It is understood that the base material can be a laboratory dental plaster that is between 50-99.9 wt. % of the formulation. The dental plaster can comprise respirable crystalline silica, quartz, SiO₂, gypsum, and/or calcium sulfate hemihydrate. The dental plaster can include gypsum plaster between 60-100 wt. % and can include quartz between 1-5 wt. %. The stiffening agent can include a polysaccharide, such as maltodextrin, for example, between 1-15 wt. % of the formulation. It is understood that the bonding agent can be a polyvinyl alcohol (PVA) between 1-15 wt. % of the formulation. The accelerating agent can be any known compound for reducing a setting time of the base material. The accelerating agent can be between 1-10 wt. % of the formulation. The lubricant can be magnesium stearate, for example, at between 0.1-5 wt.% of the formulation. The desiccant can be anhydrous magnesium sulfate between 1-5 wt. % of the formulation.

In an exemplary embodiment, the powder includes the components and weight percentages shown in Table 2.

TABLE 2
First Embodiment of a Powder Formulation.

| component | weight % |
|---|---|
| dental plaster | 75 +/− 1 |
| polyvinyl alcohol | 7 +/− 1 |
| maltodextrin | 7 +/− 1 |
| accelerating agent | 4 +/− 0.5 |
| magnesium stearate | 2 +/− 0.5 |
| magnesium sulfate, anhydrous | 4 +/− .05 |

In another exemplary embodiment, the powder includes the components and weight percentages shown in Table 3.

TABLE 3
Second Embodiment of a Powder Formulation.

| component | function | weight % |
|---|---|---|
| dental plaster | base material | 52.1 |
| lactose | glidant | 26.1 |
| maltodextrin | stiffening agent | 7.8 |
| polyvinyl alcohol (PV) | bonding agent | 5.2 |
| magnesium sulfate, anhydrous | desiccant | 3.9 |
| QwicKast ™ | accelerator | 2.6 |
| microcrystalline cellulose type 102 | glidant | 1.6 |
| magnesium stearate | hydrophobic lubricant | 0.3 |
| colloidal silica | glidant | 0.4 |

The base material can accordingly include plaster as the primary component. Using dental plaster can reduce expansion of the printed article and can also reduce the set time. An accelerating agent, such as QwicKast™, can be used to further reduce the set time of the plaster and can allow for faster removal of a printed article or powder article from a 3D printing machine. Maltodextrin and polyvinyl alcohol components can improve the flow of the powder and resulting strength of the part. Amounts of these components can be readily tailored to work with the dental plaster as the base material.

Printed articles using the powders described herein can be wet. Various desiccants, such as anhydrous magnesium sulfate, can be used to tailor the effect of moisture. Amount of desiccant can be adjusted so that the moisture content and effects thereof achieve an acceptable state.

To improve powder flow, a lubricant such as magnesium stearate can be used. Improving powder flow with the lubricant can result in a more uniform layer of powder when the powder is spread in the printing machine when forming each cross section of the article being printed. To further enhance the powder flow, another glidant, such as colloidal silica which functions as a particle lubricant, can be added to the powder.

The base material including the plaster, the colloidal silica, magnesium sulfate, and accelerating agent (e.g., QwicKast™) can be mixed first, then the lubricant (e.g., magnesium stearate) can be added and mixed into the powder. In this manner, it is believed that the colloidal silica fills gaps in the plaster particles, where the magnesium stearate then coats and seals the more uniform plaster particles to some degree. This preparation and mixing method facilitates and improves the flow of the plaster powder in the 3D printing machine.

Glidants can be added to the powder. For example, addition of microcrystalline cellulose can help with powder flow. Microcrystalline cellulose is also referred to as an anti-caking agent in certain industries, as it can absorb moisture and coat ingredients. Lactose can also improve particle flow in the powder. However, it has been found that lactose can also add significant strength to the printed article, including adding strength to the printed article after contacting the powder with the binder, and further adding strength to the printed article after infiltration and/or further treatment processes.

The following aspects apply to compositions of the binder used in the present technology. With respect to a base material including plaster containing calcined gypsum (calcium sulfate), lime, and/or cement, the binder can include water. Additional components can be added to the water in order to reduce foaming, minimize bubbles, improve wetting ability, and to preserve the binder solution. For example, the binder can include water and one or more of glycerin, propylene glycol, a surfactant to reduce surface tension, and an algaecide. Examples of surfactants include compounds known to act as detergents, wetting agents, emulsifiers, foaming agents, and dispersants. Particular examples include nonionic organosilicone-based surfactants, such as Kinetic™ surfactant by Helena (Collierville, Tenn.) and nonionic surfactants having a hydrophilic polyethylene oxide chain and an aromatic hydrocarbon lipophilic or hydrophobic group, such as Triton X-100. The binder formulation can also be tailored to the particular dispensing device used in the 3D printing system. For example, the cooperative powder and binder formulations provided herein can optimize dispensing from an inkjet printer head, improving the function and lifespan of the print head. Addition of glycerin can extend the life of the printhead and addition of propylene glycol can allow the same binder to be used as a binder for base material including potassium silicate, such as used to form a sand core.

The binder can include one or more components that are capable of binding the powder when applied thereto. Alternatively, or in addition to, the binder can include one or more components that activate or cause one or more components of the powder to bind to each other. For example, when the powder includes a plaster such as gypsum, application of water in the binder can cause the plaster in the powder to harden by the transformation of calcium sulfate hemihydrate to calcium sulfate dihydrate. As another example, when the powder includes sand for forming a sand core, the powder can include potassium silicate so that application of the binder fluid can set the potassium silicate in the powder of the 3D printer. The binder applied to the sand formulation can include water and/or propylene glycol to set such sand formulations including silicate.

A binder formulation according to the present technology can include an aqueous solution of the components provided in Table 4.

TABLE 4
Binder Formulation.

| component | function | weight % |
|---|---|---|
| water | sets plaster | 91.1 |
| glycerin | keeps head temp down | 4.5 |
| propylene glycol | setting agent for potassium silicate | 3.7 |
| Triton X-100 | surfactant | 0.3 |
| nonionic organosilicone | surfactant | 0.3 |
| (e.g., Kinetic ™) | | |
| Algaecide 60 Plus | algaecide | 0.1 |

The following aspects apply to compositions of the wash fluid used in the present technology. The wash fluid can include an aqueous solution, including water and various additives. Certain embodiments of the wash fluid include water and one or more of soap, acetic acid (e.g., as white vinegar), and algaecide. The soap component can be based on laundry detergent, including laundry detergents having anionic surfactants (e.g., alkylbenzenesulfonate surfactants), alkaline builders, and/or water softening agents. Where the base material includes plaster containing calcined gypsum (calcium sulfate), lime, and/or cement, the acetic acid (e.g., as white vinegar) can act to retard the plaster and keep it from building up on the binder dispenser; e.g., inkjet printhead. The soap can function as a plaster release agent and can help keep the plaster that does set on the binder dispenser from sticking thereto. Examples of useful soaps include various laundry detergents, and in certain embodiments the soap is Purex™ laundry detergent (Free & Clear) by Henkel North American Consumer Goods (Stamford, Conn.). Purex™ laundry detergent (Free & Clear) lists the following components—inactive ingredients: water, sodium laureth sulfate, ethoxylated alcohol, sodium carbonate, sodium dodecylbenzenesulfonate, sodium chloride, polymer, sodium EDTA, brightener, and preservative; ingredients: water, alcohol ethoxy sulfate, linear alkylbenzene sulfonate, sodium carbonate, sodium chloride, alcohol ethoxylate, sodium polyacrylate, fatty acids, disodium diaminostilbene disulfonate, tetrasodium EDTA, methylisothiazolinone, fragrance, Liquitint Blue. Other detergents, including other laundry detergents, can be used as a release agent (also known as a parting agent) in the wash fluid formulation. Various preservatives can be added to the wash fluid, including various antimicrobials, including one or more algaecides such as polyoxyethylene(dimethyliminio)ethylene, 60% (dimethyliminio)ethylene dichloride. A commercially available algaecide is Algaecide 60 Plus for swimming pools by In The Swim (West Chicago, Ill.).

A wash fluid formulation according to the present technology can include an aqueous solution of the components provided in Table 5.

TABLE 5
Wash Fluid Formulation.

| component | function | weight % |
|---|---|---|
| water | propellant | 55.5 |
| detergent | release agent | 27.7 |
| acetic acid (e.g., white vinegar) | de-foamer/plaster retardant | 16.7 |
| Algaecide 60 Plus | algaecide | 0.1 |

The following aspects apply to compositions of the infiltrant used in the present technology. Infiltration can include applying the infiltrant to the printed article or placing or soaking the printed article in the infiltrant. For example, the de-powdered article can be saturated with a liquid that serves to harden the de-powdered article and attain a functional, dimensionally stable, and robust article. Examples of infiltrants include one or more waxes, adhesives including various acrylates and epoxies, sealers including various urethanes, and/or hardeners.

In certain embodiments, the infiltrant includes a moisture cure urethane, such as Rexthane™ coating by Sherwin-Williams (Cleveland, Ohio).

The infiltrant may not fully infiltrate the printed article under normal atmospheric pressures. The infiltrant can therefore be placed into a vacuum chamber along with the printed article and a vacuum established (e.g., 25 mmHg) to thin the infiltrant and pull the infiltrant liquid into the 3D printed article. On printed articles with thick sections, the infiltrant (e.g., Rexthane™ can boil if present in too large of a volume, so the printed article can be hollowed or modeled with minimized dimensions (e.g., less than 1.0″ wall) to avoid any exothermic setting from overheating. Also, to help with handling and exothermic reactions, the inside of the printed article can be infiltrated first under normal atmospheric pressure, then left to set up. After this, a vacuum chamber can be used to completely infiltrate any remaining portions of the printed article. Multiple separate vacuum infiltrations can be used to achieve a desired density of infiltrant inside the printed article. In many cases, without additional infiltration the printed article may experience substantial shrinkage and warpage. Using more than one vacuum infiltration step can therefore be important in generating a dimensionally stable printed article as well as an accurate embodiment of the digital data, which is suitable for making a precise mold thereof. Other infiltrants include various epoxies, including epoxy paint and coatings, marine paints and coatings, and/or masonry paints, coatings, and sealers.

The following aspects apply to compositions of the core sand used in the present technology. The core sand is used to form an internal portion of a mold and can include a base material, in a similar fashion to the powder described herein, where the base material itself or another component of the core sand includes a component capable of setting or hardening, such as a silicate. For example, the core sand can include a sand and potassium silicate. A suitable commercially available binder including potassium silicate is KASOLV® 16 potassium silicate by PQ Corporation (Malvern, Pa.). Other examples of the core sand include sand, such as normal foundry sand, and further include a low expansion foundry sand including magnesium iron silicate (e.g., Olivine LE75), potassium silicate, albumin, maltodextrin, corn starch, magnesium sulfate, and/or bentonite. The core sand can be used in a manner similar to the powder, where a binder dispenser, such as an inkjet printhead, moves across a layer or bed of the core sand, selectively depositing a liquid binder onto the powder to complete a cross section of the article (e.g., an internal portion of a mold). Another layer or bed of core sand can then be spread across the completed cross section of the article and the binder dispensing can be repeated with each successive layer adhering to the former layer. In this case, however, the chemical and/or physical reaction that binds the core sand can result from the silicate (e.g., potassium silicate) already present in the core sand, where the binder liquid dispensed thereon can wet the core sand and activate the chemical and/or physical reaction that binds or holds the core sand together prior to further hardening or setting steps.

A printed article formed of the core sand including the sand and silicate mixture can be hardened by gassing with carbon dioxide (CO₂). Molds or cores produced with silicate binders can produce castings with minimal veining, scabbing, and penetration. Due to minimized mold wall movement, dimensional accuracy can be improved over other casting processes. The chemical and/or physical reaction that binds the core sand can be provided within the core sand itself (e.g., silicate), where the core sand is in powder form. For example, including potassium silicate in the binder liquid can damage or compromise the function of certain dispensers, including inkjet print heads. Thus, the core sand, operating like the aforementioned powder in the 3D printing process, can already include the chemical binder to which the binder fluid is then applied to wet the core sand and allow reaction of the core sand components, including the silicate. Propylene glycol can also be used in order to set the potassium silicate in the 3D printer. This can allow the printed article (e.g., core) to get hard enough to be removed from the 3D printer. Then, as the printed article (e.g., core) sets and absorbs additional carbon dioxide, it can achieve its final strength. If natural absorption is not quick enough, the printed article or core can be put in a vacuum chamber and a vacuum established. Carbon dioxide can be introduced into the vacuum chamber, and as the carbon dioxide permeates the printed article or core, it rapidly sets.

A first embodiment of core sand formulation according to the present technology can include a mixture of the components provided in Table 6.

TABLE 6
First Embodiment of a Core Sand Formulation.

| component | weight % |
|---|---|
| sand | 89.2 |
| KASOLV ® 16 potassium silicate | 8.9 |
| magnesium sulfate | 1.3 |
| maltodextrin | 0.4 |
| bentonite | 0.2 |

A second embodiment of a core sand formulation according to the present technology can include a mixture of the components provided in Table 7.

TABLE 7
Second Embodiment of a Core Sand Formulation.

| component | weight % |
|---|---|
| sand | 97.1% |
| KASOLV ® 16 potassium silicate | 2.4% |
| MgSO₄ | 0.5% |
| corn starch | 0.5% |
| albumin | 1.5% |
| bentonite | 0% |

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of three-dimensional printing of an article, the article defined by a plurality of cross sections, the method comprising:
(a) providing a layer of powder, the powder capable of hardening;
(b) selectively depositing a binder to the layer of powder to form a cross section of the article, the binder including an aqueous solution that results in hardening of the powder following contact of the binder with the powder;
(c) providing another layer of powder across the cross section of the article;
(d) selectively depositing the binder to the another layer of powder to form another cross section of the article;
(e) repeating steps (c) and (d) for each remaining cross section of the article to form a printed article;
(f) depowdering the printed article; and
(g) hardening the depowdered printed article to form a dimensionally stable printed article.

2. The method of claim 1, wherein:
the powder includes a plaster, a glidant, and an accelerating agent; and
the binder includes an aqueous solution.

3. The method of claim 1, wherein:
the powder includes a dental plaster, a glidant, an accelerating agent, a stiffening agent, a bonding agent, a lubricant, and a desiccant; and
the binder includes water, glycerin, propylene glycol, and a surfactant.

4. The method of claim 1, wherein:
the powder includes sand and a silicate; and
the binder includes water and propylene glycol.

5. The method of claim 1, wherein:
the powder includes sand, potassium silicate, albumin, maltodextrin, corn starch, magnesium sulfate, and bentonite; and
the binder includes water, glycerin, propylene glycol, and a surfactant.

6. The method of claim 1, further comprising washing a binder dispenser with a wash fluid, wherein the binder dispenser is used to selectively deposit the binder to the layer of powder, the wash fluid including water, a detergent, and acetic acid.

7. The method of claim 6, wherein the binder dispenser is an inkjet printhead.

8. The method of claim 1, wherein hardening the depowdered printed article to form a dimensionally stable printed article includes infiltrating the depowdered printed article using an infiltrant.

9. The method of claim 8, wherein the infiltrant includes a moisture cure urethane.

10. The method of claim 8, wherein infiltrating the depowdered printed article includes using vacuum to increase penetration of the infiltrant into the depowdered printed article.

11. The method of claim 1, wherein hardening the depowdered printed article to form a dimensionally stable printed article includes applying carbon dioxide to the depowdered printed article or to the article as it is printing.

12. The method of claim 1, further comprising making a mold using the dimensionally stable printed article.

13. The method of claim 1, wherein:
the powder includes a plaster, a glidant, an accelerating agent, a stiffening agent, a bonding agent, a lubricant, and a desiccant;
the binder includes water, glycerin, propylene glycol, and a surfactant;
the method further comprises washing a binder dispenser with a wash fluid, wherein the binder dispenser is used to selectively deposit the binder to the layer of powder, the wash fluid including water, a detergent, and acetic acid, and the binder dispenser includes an inkjet printhead; and
hardening the depowdered printed article to form a dimensionally stable printed article includes infiltrating the depowdered printed article using an infiltrant, wherein the infiltrant includes a moisture cure urethane.

14. The method of claim 13, further comprising making a mold using the dimensionally stable printed article.

15. The method of claim 1, wherein:
the powder includes sand, potassium silicate, magnesium sulfate, and bentonite;
the binder includes water, glycerin, propylene glycol, and a surfactant;
the method further comprises washing a binder dispenser with a wash fluid, wherein the binder dispenser is used to selectively deposit the binder to the layer of powder, the wash fluid including water, a detergent, and acetic acid, and the binder dispenser includes an inkjet printhead; and
hardening the depowdered printed article to form a dimensionally stable printed article includes applying carbon dioxide to the depowdered printed article or to the article as it is printing.

16. The method of claim 15, further comprising making a mold using the dimensionally stable printed article as an internal structure of the mold.

17. The method of claim 1, wherein:
the powder includes:
dental plaster at 40-60 wt. %;
lactose at 20-40 wt. %;
accelerator at 1-5 wt. %;
lubricant at 0.1-0.5 wt. %; and
colloidal silica at 0.1-1.0 wt. %;
and
the binder includes:
water at 80-95% wt. %;
glycerin at 2.5-7.5 wt. %; and
surfactant at 0.1-0.6 wt. %.

18. The method of claim 1, wherein:
the powder includes:
sand at 80-95 wt. %;
silicate at 5-15 wt. %;
magnesium sulfate at 0.5-2 wt. %;
maltodextrin at 0.5-3 wt. %; and
bentonite at 0.1-0.5 wt. %;
and
the binder includes:
water at 80-95% wt. %;
glycerin at 2.5-7.5 wt. %;
propylene glycol at 2.5-5 wt. %; and
surfactant at 0.1-0.6 wt. %.

19. A kit comprising a powder and a binder, wherein:
the powder includes:
dental plaster at 40-60 wt. %;
lactose at 20-40 wt. %;
accelerator at 1-5 wt. %;
lubricant at 0.1-0.5 wt. %; and
colloidal silica at 0.1-1.0 wt. %;
and
the binder includes:
water at 80-95% wt. %;
glycerin at 2.5-7.5 wt. %; and
surfactant at 0.1-0.6 wt. %.

20. A kit comprising a powder and a binder, wherein:
the powder includes:
sand at 80-95 wt. %;
silicate at 5-15 wt. %;
magnesium sulfate at 0.5-2 wt. %; and
bentonite at 0.1-0.5 wt. %;
and
the binder includes:
water at 80-95% wt. %;
glycerin at 2.5-7.5 wt. %;
propylene glycol at 2.5-5 wt. %; and
surfactant at 0.1-0.6 wt. %.
